(19) United States
(12) Patent Application Publication
(10) Pub. No.: US 2010/0119253 A1
(43) Pub. Date: May 13, 2010

(54) IMAGE FORMING APPARATUS AND METHOD FOR CLEANING IMAGE CARRIER OF THE IMAGE FORMING APPARATUS

(75) Inventor: Shinki MIYAJI, Osaka (JP)

Correspondence Address: SMITH, GAMBRELL & RUSSELL, 1130 CONNECTICUT AVENUE, N.W., SUITE 1130, WASHINGTON, DC, 20036, US

(73) Assignee: KYOCERA MITA CORPORATION, Osaka (JP)

(21) Appl. No.: 12/608,299

(22) Filed: Oct. 29, 2009

(30) Foreign Application Priority Data
Nov. 11, 2008 (JP) 2008-288414

(51) Int. Cl. G03G 15/02; G03G 15/00

(52) U.S. Cl. 399/100; 399/71

(57) ABSTRACT

In an image forming apparatus 1, disposed are: a photoreceptor drum 2; a charging roller which rotates following the photoreceptor drum 2; and a cleaning member 21 which is rotatable with being in contact with surfaces of the photoreceptor drum 2 and the charging roller 3 in an upstream side with respect to the charging roller 3 in a rotation direction of the photoreceptor drum 2. The cleaning member 21 includes a rotational shaft 21a and a brush portion 21b, rotates in a driven direction with respect to the charging roller 3 and a linear-velocity ratio of the cleaning member 21 to the charging roller 3 is smaller than 1.

This application is based on Japanese Patent Application No. 2008-288414 filed on Nov. 11, 2008, the contents of which are hereby incorporated by reference.

### BACKGROUND OF THE INVENTION

1. Field of the Invention

The present invention relates to an image forming apparatus that uses an electrographic method, and more particularly, to a charger which charges a photoreceptor.

2. Description of Related Art

Conventionally, in an image forming apparatus which uses an electrographic process, a charger for charging the surface of an image carrier (photoreceptor) is used. As chargers, a Corotron (or Scorotron) charger which is disposed with being in non-contact with a photoreceptor and charges the surface of the photoreceptor by corona discharge and a charging roller which is disposed with being in contact or non-contact with a photoreceptor and charges the photoreceptor are known. However, in recent years, to reduce ozone emissions which are harmful to the human body, charging rollers which emit less ozone are used more and more.

In an image forming apparatus which uses such a charging roller, after development is carried out by supplying toners to an electrostatic latent image which is formed on the surface of a photoreceptor, the toners or toner external additives which remain on the surface of the photoreceptor are removed by a cleaning device that includes a cleaning blade. However, foreign matter such as the toner external additives and the like which remain on the photoreceptor surface sometimes go through the cleaning blade and the foreign matter which goes through sometimes adhere to the surface of the charging roller. Especially when the charging roller is in contact with the photoreceptor, the adhesion amount is large.

In such a case, at a portion of the surface of the charging roller where the foreign matter adheres, charging for the photoreceptor becomes insufficient, and as a result of this, uneven charging occurs to deteriorate image quality. Besides, because of the adhesion of the foreign matter, the life of the charging roller can become short. However, there is a method for removing foreign matter on the surface of a charging roller.

For example, as a contact portion of a cleaning member that comes in contact with a charging roller, one end surface of the surface of the cleaning member which is present in a downstream side of a rotation direction of the charging roller and faces the charging roller is used; and a hold member for holding the cleaning member is provided with an elastic deformation prevention member that prevents the cleaning member from being deformed in the rotation direction of the charging roller together with the rotation of the charging roller; thus, a change in frictional force of the cleaning member against the charging roller is prevented from occurring, so that the cleaning member is prevented from coming off the hold member and a filming phenomenon on the charging roller caused by heat from the cleaning member is prevented form occurring.

### SUMMARY OF THE INVENTION

However, it is difficult to completely remove the foreign matter which adheres to the surface of the charging roller. Besides, in many cases, although the cleaning member cannot completely remove the foreign matter, the cleaning member is used to equally disperse the foreign matter so as to prevent the foreign matter from adhering to the surface of the charging roller locally and in a concentrative fashion, thereby preventing uneven discharge from occurring.

There is a case where foreign matter remains on the surface of a photoreceptor drum linearly, locally and in a concentrative fashion, goes through a cleaning blade and linearly adheres to the surface of a charging roller. In such a case, because the foreign matter is pressurized against the surface of the charging roller by nip pressure between the photoreceptor drum and the charging roller, it becomes difficult to equally disperse the linearly adhering foreign matter by the cleaning member. As a result of this, disadvantages of an image such as linear fogging, a linear image in a half-tone image and the like can occur.

The present invention has been made to deal with the conventional problems, and it is an object of the present invention to provide an image forming apparatus which effectively cleans the surface of a charging roller with a simple structure and prevents the image quality from deteriorating and the life of the charging roller from becoming short.

To achieve the above object, an image forming apparatus according to the present invention includes: an image carrier whose surface moves; a charging roller which is so disposed as to face the surface of the image carrier and includes a rotational shaft extending in a direction which intersects a movement direction of the surface of the image carrier; and a cleaning member which is so disposed in an upstream side with respect to the charging roller in the movement direction as to come into contact with the image carrier and the charging roller.

According to this structure, the cleaning member is so disposed in the upstream side with respect to the charging roller in the movement direction of the image carrier as to come into contact with the image carrier and the charging roller, so that it is possible to disperse foreign matter on the surface of the image carrier in advance and remove part of the foreign matter, and after the dispersion, it is possible to remove and further disperse the foreign matter adhering to the surface of the charging roller.

Thus, because it is possible not only to prevent the foreign matter from adhering to the surface of the charging roller locally and in a concentrative fashion but also reduce the adhering foreign matter, it becomes easy to remove and disperse the foreign matter on the surface of the charging roller. Accordingly, it is possible to effectively clean the surface of the charging roller and prevent the image quality from deteriorating and the life of the charging roller from becoming short.

In the image forming apparatus having the above structure according to the present invention, the cleaning member is rotatably supported being in contact with the image carrier and the charging roller, and a linear velocity of the cleaning member is different from linear velocities of the image carrier and the charging roller.

According to this structure, the cleaning member is supported rotatably being in contact with the image carrier and the charging roller, and the linear velocity of the cleaning member is different from the linear velocities of the image carrier and the charging roller; thus, because it is possible to improve sweeping performance of the cleaning member for the image carrier and the charging roller, it is possible to further improve the performance of removing and dispersing the foreign matter and conduct the removal and dispersion more easily.

In the image forming apparatus having the above structure according to the present invention, the cleaning member rotates in a driven direction with respect to the charging roller and a linear-velocity ratio of the cleaning member to the charging roller is smaller than 1.

According to this structure, the cleaning member rotates in the driven direction with respect to the charging roller and the linear-velocity ratio of the cleaning member to the charging roller is smaller than 1; thus, it is possible to maintain stable rotation of the charging roller and improve the performance of removing and dispersing the foreign matter by especially raising the sweeping performance of the cleaning member for the surface of the charging roller.

In the image forming apparatus having the above structure according to the present invention, the cleaning member includes a brush portion.

According to this structure, the cleaning member includes the brush portion; thus it is possible to reduce damage to the image carrier and to the charging roller and influence and the like which impinge on rotation of the image carrier and the charging roller. Besides, it becomes possible to make the brush portion bite into the image carrier and the charging roller, so that it is also possible to further improve the sweeping performance of the cleaning member.

In the image forming apparatus having the above structure according to the present invention, the cleaning member includes a brush portion, whose single yarn fineness is 10 T or smaller and whose density is 30 kF/inch² or larger and 300 kF/inch² or smaller.

According to this structure, the cleaning member includes the brush portion, whose single yarn fineness is 10 T or smaller and whose density is 30 kF/inch² or larger and 300 kF/inch² or smaller; thus, it is possible to further reduce the influence which impinges on rotation of the charging roller and make the influence on damage and rotation of the charging roller and the sweeping performance be compatible with each other.

In the image forming apparatus having the above structure according to the present invention, the cleaning member is a brush roller which includes: a rotational shaft that is disposed substantially in parallel with the charging roller; and a brush portion that is implanted in the rotational shaft.

According to this structure, the cleaning member is the brush roller which includes the rotational shaft that is disposed substantially in parallel with the charging roller and the brush portion that is implanted in the rotational shaft; thus, it is possible to reduce damage to the image carrier and the charging roller and the influence and the like which impinge on rotation of the image carrier and the charging roller. Besides, it becomes possible to make the brush roller bite into the image carrier and the charging roller, so that it also becomes possible to further improve the sweeping performance of the cleaning member. In addition, it also becomes possible to improve the sweeping performance by rotation of the cleaning member.

In the image forming apparatus having the above structure according to the present invention, the cleaning member is a rubber roller.

According to this structure, by employing the rubber roller as the cleaning member, it is possible to the performance of removing and dispersing the foreign matter by using elastic force and adhesive force of the rubber.

In the image forming apparatus having the above structure according to the present invention, the cleaning member is electro-conductive, that is, electrically conductive and a direct-current voltage or a direct-current voltage on which an alternating-current voltage is superposed is applied to the cleaning member.

According to this structure, by using the cleaning member which is electro-conductive and applying the direct-current voltage or the direct-current voltage on which the alternating-current voltage is superposed to the cleaning member, it is possible to carry out preliminary charging by the cleaning member before charging the image carrier by the charging roller; accordingly, it is possible to improve the charging performance for the image carrier and prevent the image quality from deteriorating. Especially, it is possible to further stabilize the preliminary charging in a case where the alternating-current voltage is applied.

In the image forming apparatus having the above structure according to the present invention, the cleaning member is electro-conductive and the substantially same voltage as a voltage of the charging roller is applied to the cleaning member.

According to this structure, by using the cleaning member which is electro-conductive and applying substantially the same voltage as the voltage of the charging roller to the cleaning member, it becomes possible to carry out preliminary charging by the cleaning member before charging the image carrier by the charging roller; accordingly, it is possible to improve the charging performance for the image carrier and prevent the image quality from deteriorating.

In the image forming apparatus having the above structure according to the present invention, the cleaning member reciprocates in a rotational-shaft direction of the charging roller.

According to this structure, the cleaning member reciprocates in the rotation-shaft direction of the charging roller; accordingly, it is possible to further improve the performance of removing and dispersing the foreign matter from the surface of the charging roller and further prevent the image quality from deteriorating. Especially, the cleaning member rotates and reciprocates, so that it is possible to give physical impulsive force to the surface of the charging roller in the rotation direction and in a direction different from the rotation direction, which is more effective.

In the image forming apparatus having the above structure according to the present invention, the cleaning member is rotatably supported being in contact with the image carrier and the charging roller; a substantially disk-shape cam member which is fitted into one end portion in a shaft direction of a rotational shaft of the cleaning member, inclined to a direction perpendicular to the shaft direction, and rotatable together with the cleaning member is disposed; and a guide member which allows the cleaning member to reciprocate in a rotational-shaft direction of the charging roller by guiding rotation of the cam member is disposed.

According to this structure, the cleaning member is rotatably supported being in contact with the image carrier and the charging roller; the substantially disk-shape cam member which is inclined to the direction perpendicular to the rotational shaft and rotatable together with the cleaning member is fitted into one end in the shaft direction of the rotational shaft of the cleaning member; and the guide member which allows the cleaning member to reciprocate in the rotational-shaft direction of the charging roller by guiding rotation of the cam member is disposed; thus, because it is possible to make the cleaning member reciprocate by using the rotation force of the cleaning member, it is possible to avoid complication of the structure.

Besides, in the image forming apparatus having the above structure according to the present invention, the charging roller rotates following the image carrier.

According to this structure, the charging roller rotates following the image carrier, and thus it is possible to reduce the influence of the charging roller impinging on the surface movement of the image carrier.

Besides, in the image forming apparatus having the above structure according to the present invention, the charging roller is disposed with being in contact with or close to the image carrier.

According to this structure, by disposing the charging roller with being in contact with or close to the image carrier, even when foreign matter on the surface of the image carrier easily adheres to the charging roller, it becomes possible to remove and disperse the foreign matter on the surface of the charging roller, which is effective.

In addition, in the image forming apparatus having the above structure according to the present invention, a direct-current voltage or a direct-current voltage on which an alternating-current voltage is superposed is applied to the charging roller.

According to this structure, especially in a case where the alternating-current voltage is applied, it is possible to make charging by the charging roller for the image carrier more stable.

In the image forming apparatus having the above structure according to the present invention, the image carrier is a photoreceptor drum.

According to this structure, by using the photoreceptor drum as the image carrier, it becomes possible to perform charging by the charging roller with the image carrier being rotated.

Besides, the present invention is a method for cleaning an image carrier of an image forming apparatus that includes: a charging roller which is so disposed as to face a moving surface of the image carrier and has a rotational shaft extending in a direction which intersects a movement direction of the surface of the image carrier; and a cleaning member which is so disposed in an upstream side with respect to the charging roller in the movement direction as to come into contact with the image carrier and the charging roller; wherein both of the charging roller and the image carrier are cleaned by the cleaning member.

According to this structure, the cleaning member cleans both of the charging roller and the image carrier by coming into contact with the image carrier and the charging roller, so that it is possible not only to disperse the foreign matter on the surface of the image carrier and remove part of the foreign matter in advance but also to remove the foreign matter which moves from the image carrier to the surface of the charging roller; accordingly, by using the cleaning member, it is possible to clean the image carrier by directly or via the charging roller removing the foreign matter on the surface of the image carrier. Accordingly, with a simple structure, it is possible to effectively clean the surface of the charging roller through the cleaning the image carrier and prevent the image quality from deteriorating and the life of the charging roller from becoming short.

### DESCRIPTION OF THE DRAWINGS

FIG. 1 is a schematic sectional view of an image forming apparatus according to a first embodiment of the present invention.

FIG. 2 is a schematic enlarged sectional view of a photoreceptor drum, a charging roller, a cleaning member and other members which are used in the image forming apparatus according the embodiment.

FIG. 3 is a schematic enlarged sectional view of a photoreceptor drum, a charging roller, a cleaning member and other members which are used in an image forming apparatus according a second embodiment of the present invention.

FIG. 4 is a schematic enlarged sectional view of a photoreceptor drum, a charging roller, a cleaning member and other members which are used in an image forming apparatus according a third embodiment of the present invention.

FIG. 5 is a plan view seen from an A direction in FIG. 4.

FIG. 6 is a plan view seen from a B direction in FIG. 5.

### DESCRIPTION OF THE PREFERRED EMBODIMENTS

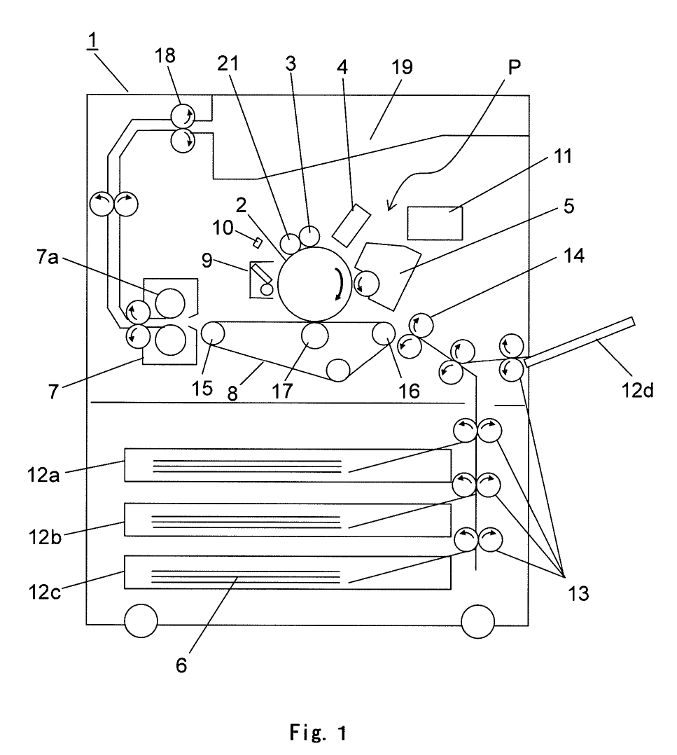

Hereinafter, embodiments of the present invention are described with reference to the drawings. FIG. 1 is a schematic sectional view of an image forming apparatus according to a first embodiment of the present invention. In an image forming apparatus 1, an image forming portion P is disposed above a convey belt 8. This image forming portion P forms a predetermined image through each process of charging, exposure, development and transfer.

In this image forming portion P, a photoreceptor drum 2 which carries a visible image (toner image) is disposed; a toner image formed on the photoreceptor drum 2 is transferred onto a sheet (recording medium) 6 which is held and conveyed by the convey belt 8 which moves adjacently to the image forming portion P, and further, fixed on the sheet 6 by a fix portion 7, then ejected from the apparatus. By rotating the photoreceptor drum 2 clockwise in FIG. 1, an image forming process is performed onto the photoreceptor drum 2.

Next, the image forming portion P is described in detail. Disposed around and over the photoreceptor drum 2 which is rotatably disposed are: a charging roller 3 which charges the photoreceptor drum 2; an exposure unit 4 which exposes image information onto the photoreceptor drum 2; a development device 5 which forms a toner image on the photoreceptor drum 2; a cleaning portion 9 which removes developer (toner) that remains on the photoreceptor drum 2; and an electricity remover 10 which removes an electrostatic latent image.

First, the surface of the photoreceptor drum 2 is equally charged by the charging roller 3; then, light is directed by the exposure unit 4 onto the photoreceptor drum 2 to form an electrostatic latent image according to an image signal on the photoreceptor drum 2. In the development device 5, a predetermined amount of toner is loaded in a toner container 11. The toner is supplied to the photoreceptor drum 2 by the development device 5 and electrostatically adheres to the photoreceptor drum 2, and thus, a toner image is formed in accordance with the electrostatic latent image which is formed by exposure by the exposure unit 4. Details of the photoreceptor drum 2, the charging roller 3 and the development device 5 are described later.

The sheets 6 onto which a toner image is transferred are stored in a plurality of paper supply cassettes 12a, 12b, 12c, and a stack bypass (manual feed tray) 12d which is disposed above them, supplied onto the convey belt 8 via paper supply rollers 13 and a resist roller 14, and conveyed to the position of the photoreceptor drum 2. A dielectric resin sheet is used for the convey belt 8: an endless belt formed by overlaying and connecting both end portions of the dielectric resin sheet or a belt (seamless belt) which has no seams is used.

The convey belt 8 is mounted on a drive roller 15 in a downstream side and a driven roller 16 in an upstream side; when the convey belt 8 starts to rotate counterclockwise, the sheet 6 is conveyed from the resist roller 14 onto the convey belt 8. Here, an image writing signal becomes ON, that is, valid, and an image is formed on the photoreceptor drum 2 at a predetermined timing. And, under the photoreceptor drum 2, by giving an electric field by a transfer roller 17 to which a predetermined transfer voltage is applied, the toner image on the photoreceptor drum 2 is transferred onto the sheet 6. The sheet 6 is held on the convey belt 8 by electrostatic attractive force. Details of the transfer are described later.

The sheet 6 onto which the toner image is transferred leaves the convey belt 8 and is conveyed to the fix portion 7. Besides, as for the photoreceptor drum 2 after the toner image is transferred, toner which remains on the surface of the photoreceptor drum 2 is removed by the cleaning portion 9 for a preparation for next formation of a new electrostatic latent image. The sheet 6 which is conveyed from the convey belt 8 to the fix portion 7 is heated and pressurized by a fix roller 7a, so that the toner image is fixed on the surface of the sheet 6 and a predetermined image is formed. The sheet 6 on which the image is formed is then ejected onto an ejection tray 19 by ejection rollers 18.

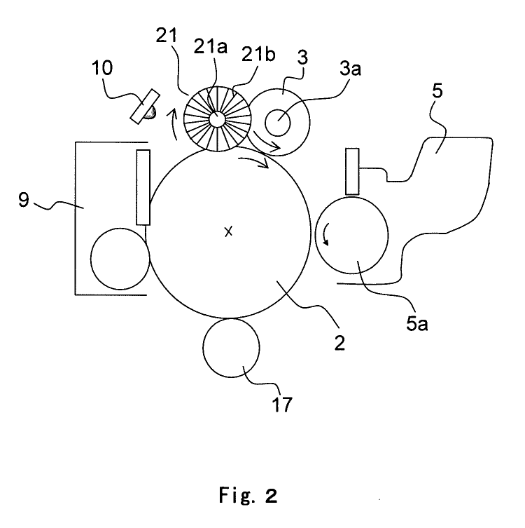

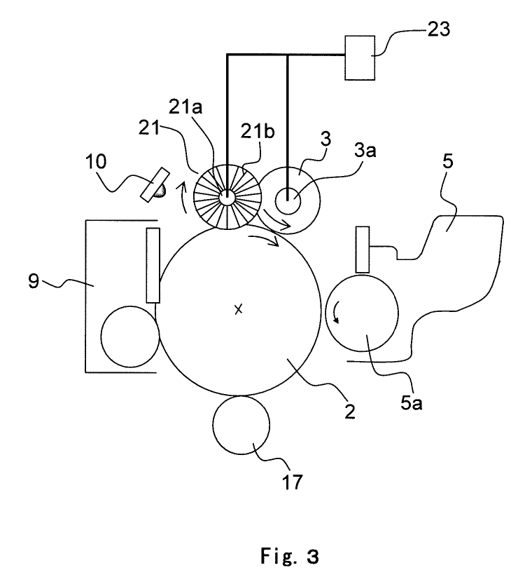

FIG. 2 is a schematic enlarged sectional view of the photoreceptor drum, the charging roller, the cleaning member and the other members which are used in the present embodiment. Portions common to FIG. 1 are indicated by common reference numbers and description of them is skipped. As the photoreceptor drum 2, an amorphous silicon drum is able to be used, for example. Besides, the photoreceptor drum 2 is connected to a drive motor, not shown, via a drive gear, not shown, so that the photoreceptor drum 2 rotates clockwise in the drawing. In addition, the surface of the photoreceptor drum 2 is equally charged at +250 V by the charging roller 3 which is electrically connected to a power source 23 (see FIG. 3) described later, for example.

The development device 5 includes a development roller 5a which is so disposed as to face the photoreceptor drum 2 in a non-contact state, and as a development bias, a rectangular wave which includes a direct-current component of +170 V and an alternating-current component that has an amplitude of 1.7 kV, a frequency of 2.5 kHz, and a DUTY ratio of 45% is applied to the development roller 5a, so that the toner on the surface of the development roller 5a is supplied to the photoreceptor drum 2 to develop an electrostatic latent image. The developed toner image is transferred onto the sheet 6 (see FIG. 1) by applying a transfer bias of −2.5 kV to the transfer roller 17.

The charging roller 3 is able to be fabricated by so forming an epichlorohydrin rubber elastic layer (the thickness is 3 mm) on a metal core 3a of φ6 mm that the roller diameter becomes φ12 mm. The elastic layer has an electric resistance of 3×10⁶ Ωcm and a rubber hardness of 45° (JISA). As the elastic layer, a solid type, for example, such as an electro-conductive roller or the like is able to be used. Besides, the charging roller 3 rotates following the photoreceptor drum 2.

And, as shown in FIG. 2, a cleaning member 21 which is rotatably supported being in a contact with the photoreceptor drum 2 and the charging roller 3 is disposed in an upstream side with respect to the charging roller 3 in the rotation direction of the photoreceptor drum 2. The cleaning member 21 is composed of: a rotational shaft 21a which is disposed substantially in parallel with the charging roller 3; and a brush portion 21b which is disposed on and around the rotational shaft 21a and in which brushes are so implanted as to come into contact with the surfaces of the photoreceptor drum 2 and the charging roller 3. The brush portion 21b is formed of a resin material such as electro-conductive nylon or the like, for example, and has an enough hardness to bite into the surfaces of the charging roller 3 and the photoreceptor drum 2.

Although it is preferable that the cleaning member 21 is a brush roller from the viewpoint for less damage to the charging roller 3 and less influence on the rotation of the charging roller 3, it is also possible to use a rubber roller. In a case of a brush roller, when the single yarn fineness becomes large, stable rotation of the charging roller 3 is adversely affected depending on structures of the apparatus. Considering such disadvantage, it is preferable that the single yarn fineness of the brush used for the brush portion 21b is 10 T or smaller, for example.

Besides, when the density of brushes becomes small, the damage to the photoreceptor drum 2 and the charging roller 3 and the influence on the rotation of the photoreceptor drum 2 and the charging roller 3 are small, but the sweeping performance tends to deteriorate; when the density becomes large, the sweeping performance rises, but the above influence on the photoreceptor drum 2 and the charging roller 3 tends to become large. Accordingly, for example, it is preferable that it is possible to suitably set the brush density considering the advantage and disadvantage, and the brush density is set to 30 kF/inch² or larger and 300 kF/inch² or smaller.

In addition, by making the brush portion 21b bite into the surface of the charging roller 3, it is possible to improve the performance of removing and dispersing foreign matter on the surface of the charging roller 3. It is possible to set the bite amount to 0.5 mm, for example. However, it is possible to suitably set the bite amount according to materials and the like of the brush portion 21b and the charging roller 3. Besides, likewise, it is also possible to set the bite amount of the cleaning member 21 for the photoreceptor drum 2 to 0.5 mm, for example.

The cleaning member 21 rotates in a driven direction (a counter direction with respect to the photoreceptor drum 2) with respect to the charging roller 3, and the linear-velocity ratio of the cleaning member 21 to the charging roller 3 is set smaller than 1. It is possible to set the linear-velocity ratio to 0.85, for example. It is possible to drive and rotate the cleaning member 21 by using a drive motor, not shown, separately from the photoreceptor drum 2, and also possible to rotate the cleaning member 21 by connecting the above drive gear of the photoreceptor drum 2 to an idle gear, not shown, and by suitably setting the gear ratio.

Next, cleaning operation by the cleaning member 21 is described. After a transfer by the transfer roller 17, foreign matter which is part of the foreign matter such as toner external additives and the like remaining on the surface of the photoreceptor drum 2 and is not collected by the cleaning portion 9 rotates together with the photoreceptor drum 2. When such foreign matter reaches a point to face the cleaning member 21, the foreign matter is swept by the brush portion 21b of the cleaning member 21 which comes into contact with the surface of the photoreceptor drum 2 while rotating, and dispersed chiefly sparsely on the surface of the photoreceptor drum 2. Here, part of the foreign matter is removed by the cleaning member 21.

Next, the foreign matter which is not removed by the cleaning member 21 further rotates together with the photoreceptor drum 2; when the foreign matter reaches a point to face the charging roller 3, the foreign matter adheres to the surface of the charging roller 3. Here, at a nip portion between the surface of the charging roller 3 and the photoreceptor drum 2, because of action of the potential on the surface of the charging roller 3 and of the pressurization force at the nip portion, the foreign matter on the surface of the photoreceptor drum 2 easily adheres to the surface of the charging roller 3. Foreign matter adhering to the surface of the charging roller 3 is swept and removed by the cleaning member 21 while the remainder is dispersed.

As described above, the cleaning member 21 comes into contact with the surface of the photoreceptor drum 2, so that first cleaning is performed in advance to disperse (preliminary dispersion) the foreign matter which remains on the surface of the photoreceptor drum 2 before the foreign matter adheres to the charging roller 3, and then second cleaning is performed to remove and disperse the foreign matter which adheres to the charging roller 3.

Besides, because it is possible to preliminarily disperse the foreign matter on the surface of the photoreceptor drum 2 by the first cleaning, it is possible to avoid a local concentration of the foreign matter on the surface. Thus, it is possible to prevent the foreign matter which collects on the surface of the photoreceptor drum 2 locally and in a concentrative fashion from being pressurized by the nip portion between the photoreceptor drum 2 and the charging roller 3 and from being fixed on the surface of the charging roller 3 with being still in the concentrated state. Accordingly, in the second cleaning, it becomes easy to remove and disperse the foreign matter adhering to the surface of the charging roller 3 by the cleaning member 21.

As described above, by performing two cleaning processes of the first and second cleaning with the cleaning member 21 being in contact with the photoreceptor drum 2 and the charging roller 3, it is possible to sufficiently remove and disperse the foreign matter which is difficult to sufficiently remove and disperse by cleaning only the surface of the charging roller 3. Thus, it is possible to effectively clean the surface of the charging roller 3 and prevent the image quality from deteriorating and the life of the charging roller 3 from becoming short. Besides, because it is possible to perform the two cleaning processes by one cleaning member 21, it is possible to obtain a simple structure and reduce the cost.

In addition, in the present embodiment, the cleaning member 21 is rotatably supported with being in contact with the photoreceptor drum 2 and the charging roller 3 and the linear velocity of the cleaning member 21 is different from the linear velocities of the photoreceptor drum 2 and the charging roller 3; accordingly, it is possible to improve the sweeping performance of the cleaning member 21 for the photoreceptor drum 2 and the charging roller 3. Thus, it is possible to improve the performance of removing and dispersing the foreign matter and make the removal and dispersion easier.

Besides, in the present embodiment, because the linear-velocity ratio of the cleaning member 21 to the charging roller 3 is smaller than 1, it is possible to raise the frictional force on the surface of the charging roller 3 by the linear-velocity difference and sufficiently use the sweeping performance of the cleaning member 21. Thus, it is possible to improve the performance of removing and dispersing the foreign matter on the surface of the charging roller 3. In addition, by making the cleaning member 21 rotate in the driven direction with respect to the charging roller 3, it is possible to maintain the stable rotation of the charging roller 3.

However, when it is possible to perform the first and second cleaning, the rotation direction and linear velocity of the cleaning member 21 is not limited. When the cleaning member 21 is rotated in a counter direction (a driven direction with respect to the photoreceptor drum 2) with respect to the charging roller 3 or the linear-velocity ratio of the cleaning member 21 to the charging roller 3 is set larger than 1, the rotation of the charging roller 3 tends to become unstable, while the performance of dispersing and removing the foreign matter on the surface of the photoreceptor drum 2 tends to improve.

Besides, in a case where the linear-velocity ratio is set to 1, there is concern that it is impossible to sufficiently improve the performance of removing and dispersing the foreign matter on the surface of the charging roller 3. Nevertheless, for example, considering such a disadvantage, so as to increase overall cleaning performance of the first-cleaning performance on the surface of the photoreceptor drum 2 and the second-cleaning performance on the surface of the charging roller 3, it is possible to suitably set the rotation direction and linear velocity of the cleaning member 21 through a preliminary experiment and the like depending on structures and the like of the apparatus. Here, although the brush portion 21b of the cleaning member 21 is electro-conductive, it may be non-electro-conductive.

In the present embodiment, because the cleaning member 21 is rotated, an excessive load is prevented from acting on the cleaning member 21; thus, it is possible to obtain a long life of the cleaning member 21 by preventing the cleaning member 21 from being deteriorated; and it is also possible to prevent the charging roller 3 from being damaged and the foreign matter from being strongly pressed and fixed on the surface of the charging roller 3. However, the cleaning member 21 may be of a stationary type.

Here, when the cleaning member 21 is of the stationary type, there is concern that the cleaning member 21 deteriorates depending on materials and the like of the charging roller 3; the charging roller 3 is damaged depending on the nip pressure between the cleaning member 21 and the charging roller 3; and the foreign matter is pressed hard and fixed on the surface of the charging roller 3, which brings concern that the structure becomes complicated to avoid these disadvantages. Accordingly, from such viewpoint, it is preferable that the cleaning member 21 is of the rotational type as in the present invention.

FIG. 3 is a schematic enlarged sectional view of a photoreceptor drum, a charging roller, a cleaning member and other members which are used in an image forming apparatus according a second embodiment of the present invention.

In the present embodiment, so that the cleaning member 21 has the same potential as the charging roller 3, the same DC voltage of +650 V is applied to the cleaning member 21 by the power source 23. As shown in FIG. 3, the rotational shaft 21a of the cleaning member 21, like the metal core 3a of the charging roller 3, is electrically connected to the power source 23. Besides, the cleaning member 21, like in the first embodiment, rotates in the driven direction with respect to the charging roller 3, but the linear-velocity ratio of the cleaning member 21 to the charging roller 3 is set larger than 1. Because others are the same as those in the first embodiment, description of them is skipped.

In the present embodiment, like in the first embodiment, by using the cleaning member 21, it is possible to perform the first cleaning for the surface of the photoreceptor drum 2 and the second cleaning for the surface of the charging roller 3. Besides, because the substantially same voltage as the charging voltage across the charging roller 3 and the photoreceptor drum 2 is also applied across the cleaning member 21 and the photoreceptor drum 2, before the charging of the charging roller 3, the cleaning member 21 is able to pre-charge (preliminary charging) the surface of the photoreceptor drum 2.

As described above, the two charging processes are performed by applying a voltage not only to the charging roller 3 but also to the cleaning member 21, thus, it is possible to sufficiently charge the photoreceptor drum 2 especially even in a low-temperature and low-humidity environment and the like where the charging performance of the charging roller 3 easily deteriorates. Thus, it is possible to prevent the image quality from deteriorating. In addition, because it is possible to perform the two cleaning processes and the two charging processes by using one cleaning member 21, it is possible to obtain a simple structure and reduce the cost.

Besides, because the charging roller 3 and the cleaning member 21 have the same potential, electrostatic force is prevented from being generated between the charging roller 3 and the cleaning member 21; accordingly, it also becomes possible, depending on kinds of the foreign matter, to improve the physical sweeping performance by the cleaning member 21 for the surface of the charging roller 3.

In the present embodiment as well, like in the first embodiment, by setting the linear-velocity ratio of the cleaning member 21 to the charging roller smaller than 1, it is possible to raise the frictional force on the surface of the charging roller 3 according to the linear-velocity difference and sufficiently use the sweeping performance of the cleaning member 21. Thus, it is possible to improve the performance of removing and dispersing the foreign matter on the surface of the charging roller 3. In addition, by making the cleaning member 21 rotate in the driven direction with respect to the charging roller 3, it is possible to maintain the stable rotation of the charging roller 3.

In the present embodiment, the cleaning member 21 is rotated in the driven direction with respect to the charging roller 3 and the linear-velocity ratio of the cleaning member 21 to the charging roller 3 is set larger than 1. By rotating the cleaning member 21 in the driven direction, like in the first embodiment, it is possible to maintain the stable rotation of the charging roller 3.

Here, unlike in the first embodiment, in the case where the above voltage is applied to the cleaning member 21, the cleaning member 21 easily electrically attracts the foreign matter especially on the photoreceptor drum 2. Thus, there is concern that the foreign matter which becomes an electric resistor is accumulated on the cleaning member 21 at high speed and the charging performance of the cleaning member 21 rapidly deteriorates.

Accordingly, in the present embodiment, the linear-velocity ratio of the cleaning member 21 to the charging roller 3 is set larger than 1. Thus, it is possible to expel the foreign matter accumulated on the cleaning member 21 in a downstream side of the rotation direction with respect to the nip portion formed by the cleaning member 21 and the charging roller 3; accordingly, it is possible to the foreign matter from being accumulated on the cleaning member 21 and prevent the charging performance of the cleaning member 21 from deteriorating.

However, the rotation direction and linear velocity of the cleaning member 21 are not limited especially: by considering not only overall cleaning performance through a balance between the first cleaning on the surface of the photoreceptor drum 2 and the second cleaning on the surface of the charging roller 3 but also the charging performance for the photoreceptor drum 2, it is possible to suitably set the rotation direction and linear velocity of the cleaning member 21 depending on structures and the like of the apparatus.

In the present embodiment, although a DC voltage is applied to the cleaning member 21, the voltage applied to the cleaning member 21 is not limited in a case where it is possible to apply the substantially same voltage as that of the charging roller 3: depending on the voltage of the charging roller 3, it is also possible to apply an AC voltage or also possible to apply a voltage which is formed by superposing an AC voltage on a DC voltage. Besides, it is also possible to suitably set the application amount depending on charging conditions and the like.

Besides, as in the present embodiment, in the case where a voltage is applied to the cleaning member 21, because the two charging processes are performed, it is necessary to form the brush portion 21b of the cleaning member 21 of an electro-conductive material.

In addition, in each of the above embodiments, although the cleaning member 21 is rotated on the rotational shaft 21a, the operation of the cleaning member 21 is not especially limited to each of the above embodiments.

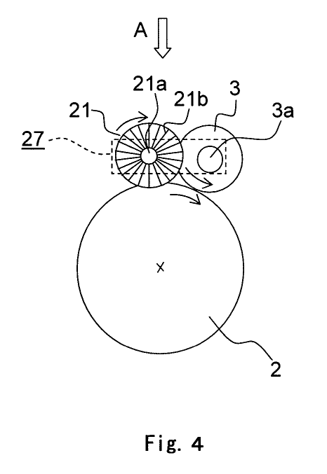

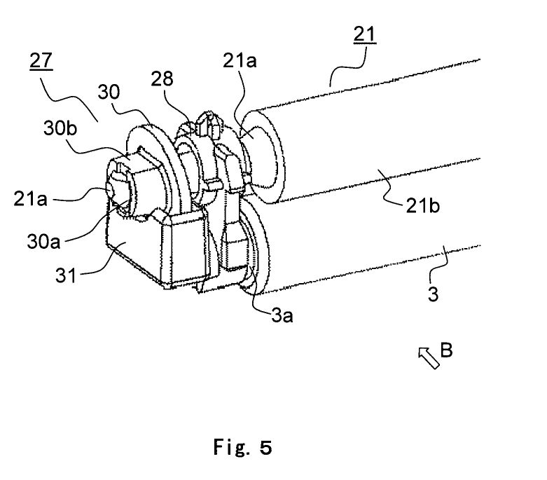

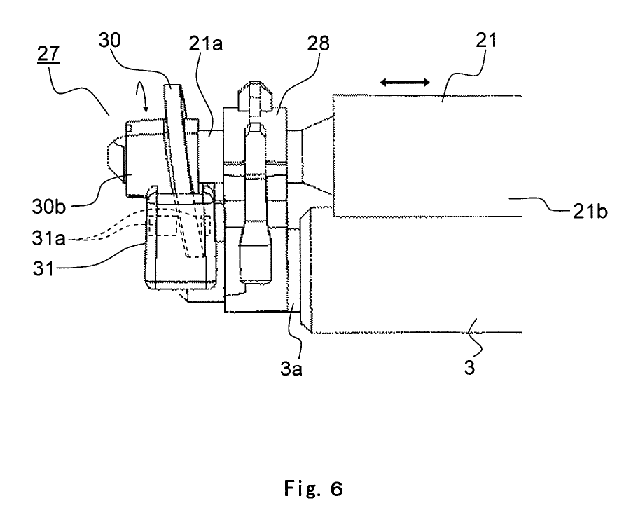

FIG. 4 is a schematic enlarged sectional view of a photoreceptor drum, a charging roller, a cleaning member and other members which are used in an image forming apparatus according a third embodiment of the present invention. FIG. 5 is a plan view seen from an A direction in FIG. 4. FIG. 6 is a plan view seen from a B direction in FIG. 5. Portions common to FIGS. 1 to 3 are indicated by common reference numbers and description of them is skipped.

In the present embodiment, as shown in FIGS. 4 to 6, a reciprocating-movement mechanism 27 which allows the cleaning member 21 to reciprocate is disposed. As shown in FIGS. 5 and 6, the reciprocating-movement mechanism 27 includes: a bearing member 28; a disk-shape cam (cam member) 30; and a case member (guide member) 31.

The rotational shaft 21a of the cleaning member 21 is rotatably supported by the bearing member 28 together with the metal core 3a of the charging roller 3. On a left end portion of the rotational shaft 21a, the disk-shape cam 30 which is bent in the shaft direction is disposed. The disk-shape cam 30 is formed by being slightly inclined to a direction perpendicular to the shaft direction with respect to a boss portion 30b that has an oval-shape hole 30a into which the rotational shaft 21a is so fitted as not to rotate.

Besides, there is provided the bottomed-end quadrangular box-shape case member 31 into which the disk-shape cam 30 is fitted. And, a pair of projections 31a which sandwich part of the outer circumferential portion of the disk-shape cam 30 from both sides in the shaft direction are formed near the bottom of the case member 31. In addition, the case member 31 is fixed to the bearing member 28, so that the case member 31 does not move in the shaft direction.

According to this, when the cleaning member 21 is driven to rotate, the disk-shaped cam 30 of the cleaning member 21 is guided by the pair of projections 31a of the case member 31, so that it is possible to make the cleaning member 21 reciprocate in the shaft direction. Because other structures are the same as of the first embodiment, description of them is skipped.

According to the present embodiment, the cleaning member 21 is able to reciprocate in the rotational-shaft direction of the charging roller 3. Thus, because it is possible to give a physical impact to the surfaces of the photoreceptor drum 2 and the charging roller 3, it is possible to raise the performance of removing and dispersing the foreign matter from the surfaces of the photoreceptor drum 2 and the charging roller 3 and prevent the image quality from deteriorating.

Besides, in the present embodiment, because the cleaning member 21 rotates on the rotational shaft 21a and reciprocates, it is possible to give a physical impact to the surface of the charging roller 3 in the rotation direction and in a direction different from the rotation direction, which is more effective. However, a structure may also be employed, in which the cleaning member 21 reciprocates only without rotating.

Here, for example, by considering the performance of removing and dispersing the foreign matter for the photoreceptor drum 2 and the charging roller 3, a level of damage given to the photoreceptor drum 2 and the charging roller 3 and a rotation stability of the photoreceptor drum 2 and the charging roller 3, it is possible to suitably set the reciprocating period of the cleaning member 21 depending on structures and the like of the apparatus.

Besides, the present invention is not limited to each of the above embodiments, and various modifications are possible within the scope which does not depart from the spirit of the present invention. For example, in the above embodiments, although the charging roller 3 is of a contact type which comes into contact with the photoreceptor drum 2, it is also possible to use a non-contact type of charging roller 3 which does not come into contact with the photoreceptor drum 2. In addition, it is also possible to dispose the charging roller 3 close to the photoreceptor drum 2.

The amount of foreign matter adhering to the non-contact type is dramatically less than the amount of foreign matter adhering to the contact type. Nevertheless, especially in a case where foreign matter such as toner external additives and the like go through in a concentrative fashion, because there is concern that the foreign matter can adhere to the surface of the charging roller 3, it can become necessary to remove and disperse the foreign matter on the surface of the charging roller 3 in the non-contact type as well.

In addition, the present invention is applicable to various image forming apparatuses, that is, for example, copy machines such as a digital multi-function machine, a tandem type color copy machine, an analog monochrome copy machine and the like, or facsimile machines, laser printers and the like.

Hereinafter, although the present invention is described in more detail by using examples, the present invention is not limited to the examples.

### Example 1

By using the image forming apparatus in the following experiments 1 and 2, under a normal-temperature and normal-humidity environment (23° C., 50% RH), a first durability test is performed, in which a text image (character image) having a print rate of 5% is continuously printed on 300 thousand plain paper sheets; and the quality of the printed images is evaluated.

### <Experiment 1>

The image forming apparatus according to the first embodiment of the present invention shown in FIG. 1 is used. The material of the brush portion 21b of the cleaning member 21 is electro-conductive nylon which has a single yarn fineness of 2.3 T (the total fineness of 220 T/96F), a density of 60 kF/inch²; the bite amounts of the brush portion 21b into the photoreceptor drum 2 and the charging roller 3 are each set to 0.5 mm. Besides, the charging roller 3 is driven to rotate at the same linear velocity of the photoreceptor drum 2.

The cleaning member 21 rotates in the driven direction with respect to the charging roller 3 and the linear-velocity ratio of the cleaning member 21 to the charging roller 3 is set to 0.85. Besides, a charging DC voltage of +650 V is applied to the charging roller 3. Under such conditions, the first durability test is performed. Results are shown in a table 1.

### <Experiment 2>

The first durability test is performed under the same conditions as the experiment 1 except that the cleaning member 21 is rotated with being kept in contact with only the charging roller 3. Results are shown in the table 1.

TABLE 1

| | Experiment 1 | Experiment 2 |
|---|---|---|
| Results of the first | No deterioration found | Linear fogging |
| durability test | in the image quality up to | occurs from 120 |
| | 300 thousand paper sheets | thousand paper sheets |

As shown in the table 1, in the case of the experiment 1 that meets the structure of the present invention in which the cleaning member 21 is kept in contact with the photoreceptor drum 2 and the charging roller 3, image-quality deterioration in the printed images is not found up to 300 thousand paper sheets. On the other hand, in the case of the experiment 2 that does not meet the structure in which the cleaning member 21 is rotated with being kept in contact with the charging roller 3, linear fogging occurs in the printed images from 120 thousand paper sheets, that is, deterioration in the image quality is clearly found. Besides, for example, when it is assumed that 300 thousand paper sheets are contained in a maintenance cycle, it is possible to prevent deterioration in the image quality for the maintenance cycle in the experiment 1 while it is not possible to prevent deterioration in the image quality completely for the maintenance cycle in the experiment 2.

From these results, it is understood that by making the cleaning member 21 come into contact with the photoreceptor drum 2 and the charging roller 3, it is possible to remove and disperse foreign matter on the surface of the charging roller 3; accordingly, it is possible to prevent the foreign matter from adhering to the surface of the charging roller 3 locally and in a concentrative fashion, so that it is possible to prevent the image quality from deteriorating. Besides, it is understood that it is possible to prevent a shortened life of the charging roller 3 due to the adhering foreign matter.

### Example 2

Further, a second durability test is performed in conditions severer than those in the above example 1. Specifically, under a normal-temperature and normal-humidity environment (23° C., 50% RH), a text image (character image) having a print rate of 5% is continuously printed on 300 thousand plain paper sheets; and during the continuous printing, the text image is printed under a low-temperature and low-humidity environment (10° C., 20% RH) every 50 thousand paper sheets and the image quality of the printed images is evaluated.

### <Experiment 3>

The image forming apparatus according to the second embodiment of the present invention shown in FIG. 3 is used. The second durability test is performed under the same conditions as those in the experiment 1 except that a DC voltage of +650 V is applied by the power source 23 not only to the charging roller 3 but also to the cleaning member 21. Results are shown in a table 2.

### <Experiment 4>

The second durability test is performed by using the image forming apparatus for the experiment 1. Specifically, a DC voltage of +650 V is applied to the charging roller 3 only while no voltage is applied to the cleaning member 21. Results are shown in the table 2.

TABLE 2

| | Experiment 3 | Experiment 4 |
|---|---|---|
| Results of the | No deterioration found | Linear fogging |
| second | in the image quality up | occurs from 200 |
| durability test | to 300 thousand paper sheets | thousand paper sheets |

As shown in the table 2, in the case of the experiment 3 in which the cleaning member 21 is kept in contact with the photoreceptor drum 2 and the charging roller 3; and the same voltage as that of the charging roller 3 is applied to the cleaning member 21, image-quality deterioration in the printed images is not found up to 300 thousand paper sheets. On the other hand, in the case of the experiment 4 in which no voltage is applied to the cleaning member 21, linear fogging is occurs in the printed images from 200 thousand paper sheets, that is, deterioration in the image quality tends to be clearly found in the severer low-temperature and low-humidity environment.

From these results, it is understood that when the cleaning member 21 is kept in contact with the photoreceptor drum 2 and the charging roller 3, the image quality tends to deteriorate in the second durability test which is performed under the severer environment while it is possible to sufficiently prevent the image quality from deteriorating in the first durability test which is performed in the normal environment. On the other hand, it is understood that by not only keeping the cleaning member 21 in contact with the photoreceptor drum 2 and the charging roller 3 but also applying the same voltage as that of the charging roller 3 to the cleaning member 21, it is possible to sufficiently prevent the image quality from deteriorating even in the severer second durability test.

As described above, it is understood that by applying the above voltage to the cleaning member 21, it is possible to improve the charging performance for the photoreceptor drum 2, and it is possible to further prevent the image quality from deteriorating.

According to the present invention, because it becomes easy to remove and disperse foreign matter on the surface of the charging roller, it is possible to effectively clean the surface of the charging roller with a simple structure and prevent the image quality from deteriorating and the life of the charging roller from becoming short. Besides, by rotatably supporting the cleaning member in the contact state with the image carrier and the charging roller and using the linear velocity of the cleaning member different from the linear velocities of the image carrier and the charging roller, it is possible to improve the sweeping performance of the cleaning member; accordingly, it is possible to further improve the performance of removing and dispersing the foreign matter.

Besides, by rotating the cleaning member in the driven direction with respect to the charging roller and setting the linear-velocity ratio of the cleaning member to the charging roller smaller than 1, it is possible not only to maintain the stable rotation of the charging roller but also improve the performance of removing and dispersing the foreign matter. In addition, by using a brush roller as the cleaning member, it is possible to further improve the sweeping performance of the cleaning member. Moreover, by using a brush roller, as the cleaning member, which includes a rotational shaft disposed substantially in parallel with the charging roller and a brush portion implanted in the rotational shaft, it is possible to further improve the sweeping performance of the cleaning member.

Besides, by setting the single yarn fineness of the brush portion of the brush roller to 10 T or smaller and the density to 30 kF/inch² or larger and 300 kF/inch² or smaller, it is possible to further reduce the influence on rotation of the charging roller and make the influence on damage and rotation of the charging roller and the sweeping performance compatible with each other. In addition, by using a rubber roller as the cleaning member, it is possible to improve the performance of removing and dispersing the foreign matter with the aid of elastic force and attractive force of the rubber. Moreover, by using an electro-conductive cleaning member and applying a DC voltage or a DC voltage on which an AC voltage is superposed to the cleaning member, it is possible to improve the charging performance for the image carrier and further prevent the image quality from deteriorating.

Also by applying the substantially same voltage as that of the charging roller to the cleaning member, it is possible to improve the charging performance for the image carrier. Besides, also by separately applying DC voltages that are the substantially same as each other or DC voltages on which an AC voltage is superposed and which are substantially the same as each other to the cleaning member and the charging roller, it is possible to improve the charging performance for the image carrier. Especially in the case where the above AC voltage is applied, it is possible to more stabilize the charging of the cleaning roller and the charging roller.

In addition, because the cleaning member reciprocates in the rotational-shaft direction of the charging roller, it is possible to further prevent the image quality from deteriorating. Besides, a substantially disk-shape cam member which is inclined to a direction perpendicular to the rotational shaft of the cleaning member and rotatable together with the cleaning member is fitted into one end in the shaft direction of the rotational shaft of the cleaning member; and a guide member which allows the cleaning member to reciprocate in the rotational-shaft direction of the charging roller by guiding rotation of the cam member is disposed; thus, it is possible to avoid complication of the structure. Because the charging roller rotates following the image carrier, it is possible to reduce the influence of the charging roller on the movement of the surface of the image carrier.

Besides, by so disposing the charging roller as to be in contact with or close to the image carrier, even when the foreign matter on the surface of the image carrier easily adheres to the charging roller, it becomes possible to remove and disperse the foreign matter on the surface of the charging roller. By applying a direct-current voltage or a direct-current voltage on which an alternating-current voltage is superposed to the charging roller, the charging for the image carrier by the charging roller becomes more secure. By using the image carrier as the photoreceptor drum, it becomes possible to perform the charging by the charging roller with the image carrier being rotated. In addition, by so disposing the cleaning member as to come into contact with the image carrier and the charging roller, it is possible to effectively clean the surface of the charging roller with a simple structure through the cleaning of the image carrier, so that it is possible to prevent the image quality from deteriorating and the life of the charging from becoming short.

What is claimed is:

1. An image forming apparatus comprising:
an image carrier whose surface moves;
a charging roller which is so disposed as to face the surface of the image carrier and includes a rotational shaft extending in a direction which intersects a movement direction of the surface of the image carrier; and
a cleaning member which is so disposed in an upstream side with respect to the charging roller in the movement direction as to come into contact with the image carrier and the charging roller.

2. The image forming apparatus according to claim 1, wherein the cleaning member is rotatably supported being in contact with the image carrier and the charging roller, and a linear velocity of the cleaning member is different from linear velocities of the image carrier and the charging roller.

3. The image forming apparatus according to claim 1, wherein the cleaning member rotates in a driven direction with respect to the charging roller and a linear-velocity ratio of the cleaning member to the charging roller is smaller than 1.

4. The image forming apparatus according to claim 1, wherein the cleaning member includes a brush portion.

5. The image forming apparatus according to claim 1, wherein the cleaning member includes a brush portion, whose single yarn fineness is 10 T or smaller and whose density is 30 kF/inch² or larger and 300 kF/inch² or smaller.

6. The image forming apparatus according to claim 1, wherein the cleaning member is a brush roller which includes: a rotational shaft that is disposed substantially in parallel with the charging roller; and a brush portion that is implanted in a circumference of the rotational shaft.

7. The image forming apparatus according to claim 1, wherein the cleaning member is a rubber roller.

8. The image forming apparatus according to claim 1, wherein the cleaning member is electrically conductive and a direct-current voltage or a direct-current voltage on which an alternating-current voltage is superposed is applied to the cleaning member.

9. The image forming apparatus according to claim 1, wherein the cleaning member is electrically conductive and the substantially same voltage as a voltage of the charging roller is applied to the cleaning member.

10. The image forming apparatus according to claim 1, wherein the cleaning member reciprocates in a rotation-shaft direction of the charging roller.

11. The image forming apparatus according to claim 1, wherein
the cleaning member is rotatably supported being in contact with the image carrier and the charging roller;
a substantially disk-shape cam member which is fitted into one end portion in a shaft direction of a rotational shaft of the cleaning member, inclined to a direction perpendicular to the shaft direction, and rotatable together with the cleaning member is disposed; and
a guide member which allows the cleaning member to reciprocate in a rotational-shaft direction of the charging roller by guiding rotation of the cam member is disposed.

12. The image forming apparatus according to claim 1, wherein the charging roller rotates following the image carrier.

13. The image forming apparatus according to claim 1, wherein the charging roller is disposed with being in contact with or close to the image carrier.

14. The image forming apparatus according to claim 1, wherein a direct-current voltage or a direct-current voltage on which an alternating-current voltage is superposed is applied to the charging roller.

15. The image forming apparatus according to claim 1, wherein the image carrier is a photoreceptor drum.

16. A method for cleaning an image carrier of an image forming apparatus that includes: a charging roller which is so disposed as to face a moving surface of the image carrier and has a rotational shaft extending in a direction which intersects a movement direction of the surface of the image carrier; and a cleaning member which is so disposed in an upstream side with respect to the charging roller in the movement direction as to come into contact with the image carrier and the charging roller;
wherein both of the charging roller and the image carrier are cleaned by the cleaning member.
